(19) United States
(12) Patent Application Publication
(10) Pub. No.: US 2017/0338028 A1
(43) Pub. Date: Nov. 23, 2017

(54) INTEGRATED ELECTRICAL COIL AND COIL STACK ASSEMBLY

(71) Applicant: WESTINGHOUSE ELECTRIC COMPANY, LLC, CRANBERRY TOWNSHIP, PA (US)

(72) Inventors: GREGORY E. FALVO, SUFFIELD, CT (US); BRUCE F. ALLEN, GRANBY, CT (US)

(73) Assignee: WESTINGHOUSE ELECTRIC COMPANY, LLC, CRANBERRY TOWNSHIP, PA (US)

(21) Appl. No.: 15/160,758

(22) Filed: May 20, 2016

(51) Int. Cl. H01F 27/28; H01F 27/32; H01F 27/02

(52) U.S. Cl. CPC H01F 27/2823; H01F 27/025; H01F 27/325

(57) ABSTRACT

An improved electrical coil unit is described which includes generally a coil member encapsulated within an iron-containing metal housing wherein the housing has an increased surface area to better transfer heat and provide air flow during operation. Each coil unit includes a coil member comprising a bobbin made of a non-conducting fiberglass impregnated resin and an insulated copper wire coiled around the outer surface of the bobbin member in multiple layers. Each coil unit is housed in an iron containing metal housing. The exterior surface of the housing preferably includes a plurality of fins extending longitudinally around the housing. A coating material is provided to encapsulate the coil member within the housing to form an integrated coil unit. The integrated coil units may be stacked to form a coil stack assembly.

### BACKGROUND OF THE INVENTION

### 1. Field of the Invention

The invention relates to high temperature coils and coil stack assemblies for use in industrial settings.

### 2. Description of the Prior Art

In industrial settings where electrical power demands for operating various kinds of equipment are high, electrical power is often provided by electrical coils which create a magnetic field that magnifies the power generated from the electric coil. An electromagnetic coil is essentially an electrical conductor such as a wire in the shape of a coil, often wound multiple times around a cylinder or other coil form, made of plastic or another non-conducting material to hold the coil in place. Electrical current that runs through the wire conductor creates a circular magnetic field around the wire. The coil shape amplifies the strength of magnetic field produced. To prevent the current from passing between the adjacent wire loops, or turns, the wire is insulated with a coating of nonconductive insulation such as plastic or enamel. The ends of the wire are brought out and attached to an external circuit.

Gripper coils are used in drive assemblies, such as control element drive mechanisms (CEDM) used in power generating plants, and particularly in some nuclear power generating plants. A stack of coils surrounds an elongate cylinder through which the shaft of a drive assembly passes.

Coils have heretofore been designed using solid copper wire coated with a baked enamel insulation. The insulated copper wire is wound into a coil while using a wet enamel varnish to hold the wire windings together. Thereafter, the coil is baked to cure the enamel. The coil is placed in a mold and surrounded by a vulcanizing silicone material and baked again to cure the silicone. The silicone coated coil is placed in a steel housing and stacked with other housed coils to form a coil stack assembly, which may, for example, be used to operate the control rod drive mechanism or may be used for a similar application.

The placement of the coil within the housing has been found to create air gaps between the inside surface of the housing cylinder and the exterior of the coil, and the silicone material has been found to inhibit the transfer of heat. The combined impact of the inhibition of heat transfer and the air gaps limits the conventional coil design to very low temperature applications of about 350° F. It has been found that thermal exposure above 350° F. causes the varnish to fail and become very conductive, losing its insulating properties. Additionally, the center winding of the coil may become overheated due to insufficient air cooling. Both of these events leads to electrical shorting between the copper wire windings, which may cause the electrical resistance of the coil to drop. Because the drive mechanism requires a constant voltage, a decrease in resistance causes an increase in current in the coil, and higher operating temperatures for the coil.

There is a cascade of events that leads to further electrical shorts between the wire windings within the coil and very high temperatures, in excess of design tolerance, which ultimately progress to the inability of the coil to generate enough magnetic flux to properly operate the mechanism, such as a drive assembly, to which the coil or coil stack assembly is operatively connected. In the event of coil failure, the coils within the stack assembly or the entire coil stack have to be replaced. The electrical coils are fragile and replacing them without incidence can be difficult. Often, the replacement coils are damaged when attempts to replace the spent coils are made.

### SUMMARY OF THE INVENTION

The risks of coil overheating and the cascade of events leading to failure of the coil are addressed by the improved coil unit design described herein. The improved design provides an electrical coil operable at temperatures up to, and even greater than, 500° F., and preferably at temperatures between 390° F. and 500° F., and more preferably at temperatures between 392° F. and 500° F. The electrical coil unit described herein generally includes a coil member encapsulated within an iron-containing metal housing wherein the housing has an increased surface area to better transfer heat and provide air flow during operation.

The improved design provides an electrical coil having the following features: a coil member comprising (i) a bobbin made of a non-conducting fiberglass impregnated resin material, the bobbin having outer and inner surfaces and defining an open interior, and (ii) an insulated copper wire coiled around the outer surface of the bobbin in multiple layers; an iron containing metal housing defining an open interior having a central axis, an exterior surface, and being configured for receiving the coil member therein, the exterior surface of the housing having a plurality of fins extending longitudinally in a direction substantially parallel to the central axis; and, a coating material encapsulating the coil member within the housing to form an integrated coil unit.

The copper wire is preferably unvarnished. Elimination of the enamel varnish used in conventional coils provides improved performance results. The copper wire may be insulated with fiberglass filaments, which in certain preferred embodiments comprise a plurality of fiberglass threads, each thread having a diameter of 0.0002 to 0.0003 inches (0.0058 to 0.00762 mm). In certain aspects, the wire insulation may include at least one filament that is tightly wrapped in a clockwise direction and at least a second filament that is tightly wrapped in a counterclockwise direction around the length of wire such that no gaps or exposed wire remain. In various aspects of the coil unit described herein, the insulated copper wire preferably extends outwardly from the coil unit for electrically connecting the coil unit to an external connector.

The coating material may be a cured silicone. The bobbin may be made of a fiberglass impregnated epoxy resin. The housing may be made of a carbon steel.

The fins on the exterior of the housing may be in the form of a plurality of semi-circular grooves formed into the exterior surface of the housing such that the outwardly extending arcs of the curve form the fins. The housing may further include a first annular plate defining a floor section on which the coil member sits. The first annular plate may be integrally fastened or may be removably fastened to the housing, preferably with bolts or any other suitable fastener. The housing may further include a second annular plate defining a roof section for securing the coil member within the housing. The second annular plate is preferably removably fastened to the housing, preferably with bolts or any other suitable fastener.

Any of the various aspects of the coil unit described herein may be used in a coil stack assembly. The assembly includes a plurality of electrical coil units as described herein stacked axially to form a stacked column of coil units. The assembly may have at least four stacked coil units. In various aspects, the assembly further includes at least one spacer positioned between any of two stacked coil units. For example, the column of coil units may comprise a first coil unit, a second coil unit stacked on the first coil unit, a spacer stacked on the second coil unit, a third coil unit stacked on the spacer, and a fourth coil unit stacked on the third coil unit. In various aspects, a fifth coil unit may be included in the column of coil units. The fifth coil unit may be positioned between one of the first and second coil units or the third and fourth coil units, or between a coil unit and a spacer.

### BRIEF DESCRIPTION OF THE DRAWINGS

The characteristics and advantages of the present disclosure may be better understood by reference to the accompanying figures.

FIG. 1 is a perspective view of an embodiment of a coil and housing unit described herein.

FIG. 2 is a top plan view of an embodiment of a coil and housing unit described herein.

FIG. 3 is a side section view of the coil and housing unit of FIG. 2 through the line A-A.

FIG. 4 is a section view of an embodiment of the insulated copper wire used in the coil of FIG. 1 or FIG. 2.

FIG. 5 is a side, partial section view of an embodiment of a coil stack assembly showing four coil and housing units and a spacer positioned between the second and third stacked units.

FIG. 6 is a detailed cross-sectional view of the coil stack assembly through the area B of FIG. 5.

FIG. 7 is a view of the coil stack assembly of FIG. 5 from the line C-C.

FIG. 8 is a detail view of the bolt securing a coil and housing unit of the coil stack assembly in the area A of FIG. 5.

FIGS. 9A and B are section views through the lines D-D and F-F, respectively, of FIG. 7.

### DESCRIPTION OF THE PREFERRED EMBODIMENTS

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the drawings and are not limiting upon the claims unless otherwise expressly stated.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Tightly wrapped as used herein means that the elements wrapped are so close to each other and to the item being wrapped that there are effectively no air gaps between the elements and the item being wrapped and no exposed surfaces of the item being wrapped.

The electrical coil unit 10 described herein generally includes a coil member 12 encapsulated within an iron-containing metal housing 14 wherein the housing 14 has an increased surface area to better transfer heat and provide (not block or interfere with) air flow during operation.

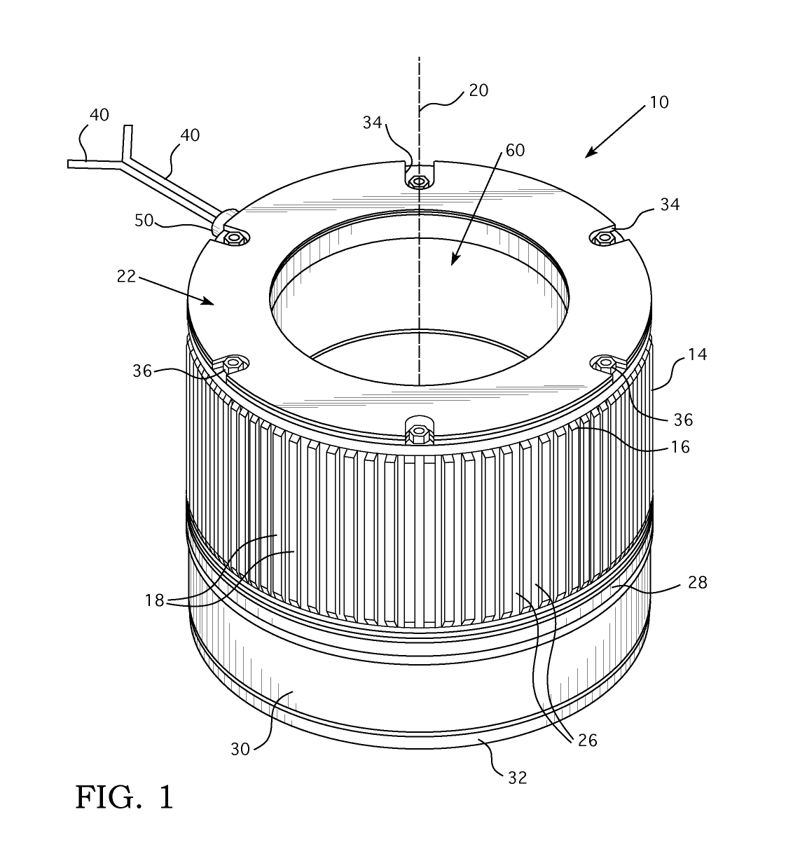

Referring to FIG. 1, in one aspect the coil unit 10 includes a housing 14 having an exterior surface 16 with fins or ribs 18 extending outwardly from the surface 16 in a longitudinal direction generally parallel or substantially parallel to the central axis 20 of the coil unit 10. The fins 18 serve to increase the surface are of the housing 14 to greatly improve heat transfer away from the electric coil winding 72 (see FIG. 3) into the surrounding air. The fins 18 may be formed by machining grooves 26 into the exterior surface 16 of the housing 14. The fins 18 and grooves 26 may be any shape in cross-section. Semi-circular grooves 26 (in cross-section) are believed to assist with air flow, but rectangular or any other shaped grooves 26 will suffice as long as a path is defined to allow air to flow around the exterior 16 of the housing 14 during operation. The housing 14 is made of an iron-containing metal, such as carbon steel, preferably a 1010-1018 carbon steel. Other suitable steel alloys and other iron-containing alloys may be used. The iron-containing housing creates a flux path for the magnetic field generated by the coil when electric current is applied to the coil. The steel housing magnifies the magnetic field.

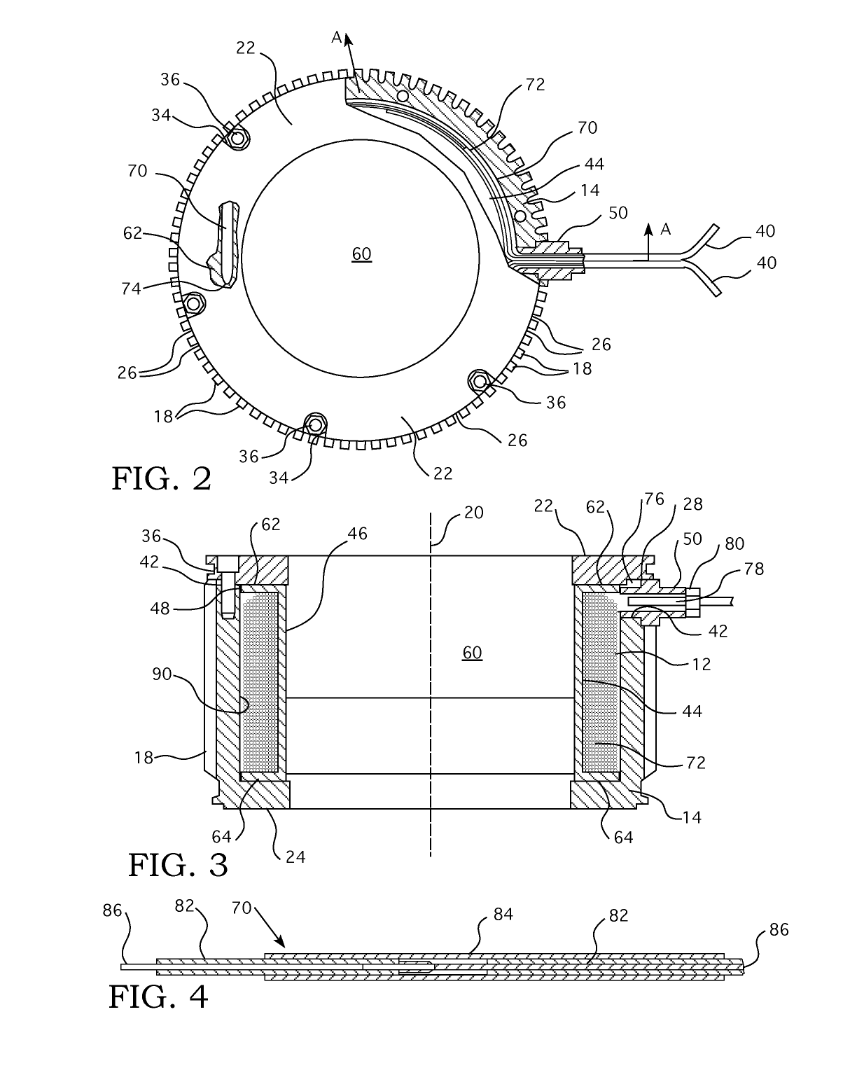

The housing 14 includes an upper plate 22 having recessed sections 34 where bolts 36 can be seated to secure the upper plate 22 to the rim 42 of the housing 14. Housing 14 also includes a lower plate 24 (see FIGS. 2 and 3). A spacer 30 is positioned adjacent the coil unit 10 as shown in FIG. 1. There are O-rings 28 between the coil unit 10 and the spacer 30. A coupler member 32 is connected to the spacer 30 at its base, as shown in FIG. 1. The spacer 30 is employed when several coil units are stacked to form a coil stack assembly 100 that will be described in more detail below. Spacer 30 is preferably made of the same material as the housing, such as carbon steel.

Referring to FIGS. 2 and 3, an embodiment of a coil unit 10 is shown in more detail. Housing 14 includes upper and lower plates 22/24. In the orientation shown, lower plate 24 provides a floor on which the bobbin 44 rests. Lower plate 24 may be integral to housing 14 or may be a separate piece fastened to a lower rim (not shown) of housing 14. Upper plate 22 is a separate piece fastened to upper rim 42 of housing 14 and, in the orientation shown, provides a roof protecting the coil windings 72. As described above, the exterior surface 16 of housing 14 includes multiple fins or ribs 18. Within housing 14 is positioned a coil member 12 comprising a bobbin 44 and an insulated copper wire 70. The bobbin 44 is made of a non-conducting material, preferably a fiberglass impregnated resin material, and more preferably a fiberglass reinforced epoxy resin, available commercially from multiple sources. The bobbin 44 has inner and outer surfaces 46/48, upper and lower flanges 62/64, and defines an open interior 60. A mica sheet 90 may be positioned on the interior surface of the housing

The insulated copper wire 70 is coiled around the outer surface 48 of the bobbin 44 in multiple layers to form the coil wire winding 72. The starting end of the wire 70 is secured to the upper flange 62 of the bobbin 44 in silicone sleeving 74. The insulated wire 70 is wound back and forth on top of itself for multiple layers, for example, fifteen layers. One rotation about the bobbin 44 is referred to as a “turn.” The wire winding 72 may, for example, comprise more than 800 turns. An exemplary winding may comprise nine or ten layers having 60-61 turns in a first direction, then two layers having about 58 turns in the opposite direction, followed by two more layers of about 57 turns back in the first direction, followed by a final layer of about 55 turns to complete the winding 72. Those skilled in the art will appreciate that equivalent windings with multiple layers of insulated wire 70 may be used.

Insulated wire 70 is preferably a fiberglass filament electrically insulated solid copper wire 86. The wire 86 may be any suitable gauge for copper wiring. In one aspect of the coil unit 10, the wire 86 may be 15 gauge. Those skilled in the art will recognize that other sizes may be useful depending on the application and the environment for use. The wire 86 is insulated, preferably with thin filaments of fiberglass thread 82/84 wound at least twice, and preferably in opposing directions, around the wire 86. In various embodiments, the wire 86 may be insulated with thin fiberglass filaments about 0.0002 to 0.0003 inch (0.0058 to 0.00762 mm) in diameter. As shown in FIG. 4, the threads of fiberglass may be wound, for example, first in a clockwise direction to form a first layer 82 of insulation and then in a counterclockwise direction to form a second layer 84 of insulation along the entire length of the wire 86 to form the insulated wire 70 used to make to coil windings 72 around the outer surface 48 of bobbin 44. The insulating fiberglass filament is tightly wrapped about the wire 86 so that all wire surfaces are covered and effectively no air gaps or bare wire remain. The fiberglass filament insulation 82/84 on the copper wire 86 allows it to operate at a higher temperature without developing internal electrical short circuits. The insulation provides a very high electrical insulation between turns of the wire 86 so that the coil of insulated wire 70 can operate at very high temperatures without the occurrence of electrical shorting between the turns of the windings 72. For example, the coil unit life is rated to be operable at a minimum of 392° F. for 60 years and is expected to be operable at a service temperature of about 500° F. for at least 60 years. Operating temperatures of about 390° F. to about 500° F. for at least 60 years are believed to be easily achieved with the improved coil unit design described herein.

The coil member 12 comprising bobbin 44 with wire windings 72 are encapsulated into housing 14 by filling the space between the bobbin 44 and coil winding 72 and the interior surface of housing 14 with a viscous liquid silicone encapsulating resin to coat the coil member and housing interior. The coated coil unit is then cured to solidify the encapsulate material. Any suitable known silicone resin may be used. An exemplary resin is manufactured by Wacker Chemie AG and sold under the trademark Silres® H62C. The advantage of encapsulating the coil member 12 within housing 14 is that it holds the windings 72 in position and provides better heat transfer as compared to conventional coil designs, which actually insulated the wires to the point of slowing heat transfer, leading to rapid heat build-up within the winding. The encapsulated coil unit 10 described herein greatly improves the thermal conduction of heat from the coil wire to the housing 14. An additional advantage of encapsulating the bobbin 44 and wire windings 72 in the housing 14 to produce an integrated coil unit 10 is the ease of handling in the event that a coil unit has to be moved or switched out with a replacement unit. In conventional designs, the coil windings have to be removed and new windings or a new bobbin with unsecured windings have to be inserted into a housing. The windings were not encapsulated into and with the housing to form an integrated unit. In the prior designs, the coils could be easily damaged from handling. The improved encapsulated integrated coil unit design enables easy replacement of a single encapsulated coil unit comprising the integrated housing, bobbin and wire windings without risk of damaging loosely wrapped coil.

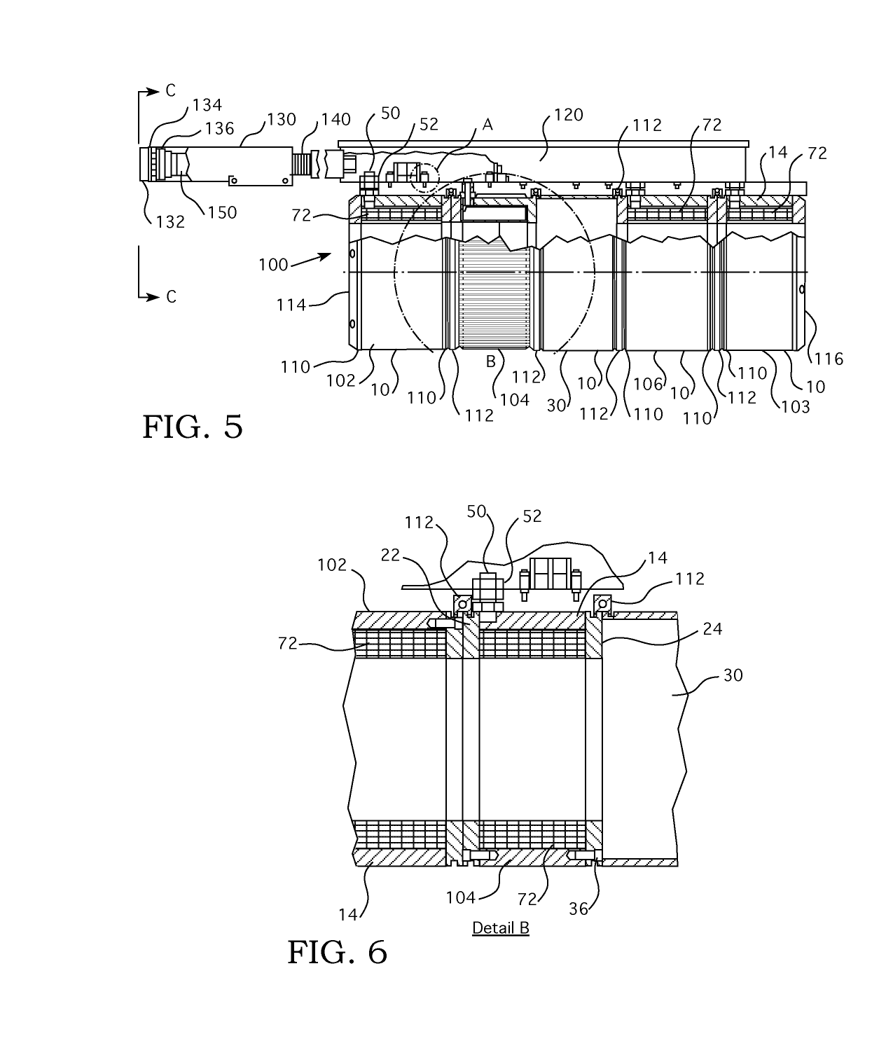

A port 50 forms an exit port for the lead wires 40 from the wire windings 72 in the coil unit 10 to an external connector, through a conduit assembly shown in FIG. 5. Port 50 extends from a recessed opening 76 in the side of housing 14 and includes a lumen through which wire 70 in the form of lead lines 40 passes. An O-ring 28 seals the port 50 in the recessed opening 76. Any suitable sealant can be coated onto the 0-ring 28 around port 50 to further secure port 50 into opening recess 76. The lead wires 40 are preferably potted, or encapsulated, into the exit end of port 50 with a silicone sleeve 78 and vulcanized rubber to eliminate wear on the wire. A silicone sleeve 78 is coated onto the lead wires 40 before application of the vulcanized rubber layer. The sleeve 78 may be flush with or positioned just inside the exit end 80 of the port 50.

Referring to FIGS. 5 and 6 (Detail B), the coil units 10 described above may be stacked to form a stacked coil assembly 100. In the embodiment shown, there are four coil units 10 and one spacer 30. In other embodiments, there may be a different number of coil units 10 in the stacked assembly depending on the power requirements in a given application. For example, there may be five coil units in a stack. For example, when used in connection with a drive mechanism, the stacked coil assembly 100 may include as a first coil unit, an upper lift coil unit 102; and may include as a second coil unit, a latch coil unit 104 adjacent to a spacer 30. A third coil unit, which may be an additional latch coil unit 106 is shown as adjacent the opposite end of spacer 30. As a fourth coil unit, a lower lift coil unit 108 may be included. Each coil unit 10 includes an end connector 110. Between each adjacent coil unit 10 and the spacer 30 is a retainer coupling ring 112 to couple the stacked units and spacer together. An upper cap 114 and lower cap 116 are placed at the ends of the coil stack assembly 100. The interior of the coil units remains open for passage of a control mechanism in certain applications of various embodiments of the stacked coil assembly 100.

As shown in FIG. 5, the stacked coil assembly 100 may be mounted on a cover assembly 120 for passage of the lead wires 40 from the port 50 into the cover assembly 120. The port 50 is connected to the cover assembly by a lock not and bolt, preferably made of stainless steel. Referring to detail A and FIG. 8, a terminal block 122 is shown and secured to the cover assembly by a fastener, such as a machine screw 124, washers 126 and 128, and a lock nut 142 assembly. The cover assembly 120 is joined to a conduit assembly 140 which houses a drive shaft 150 and terminates in a bracket 130 having end cap 132 secured in position with a fastener 134 and washer 136.

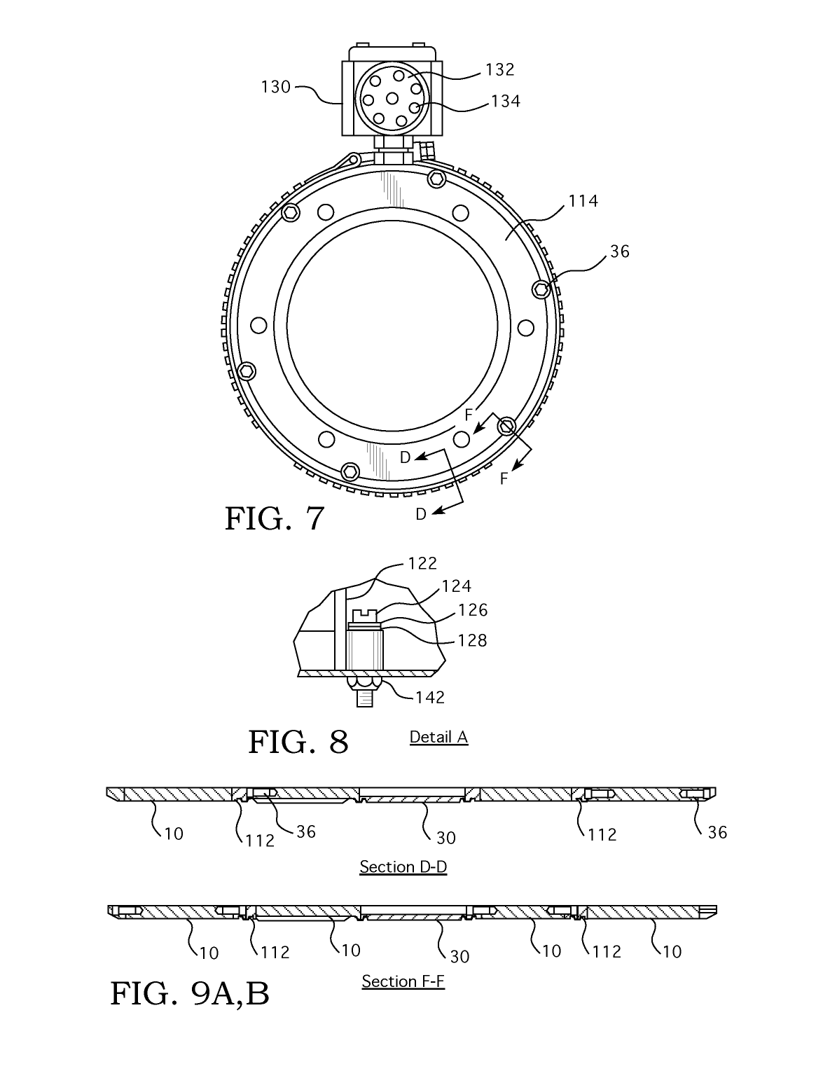

Referring to FIGS. 9 A and B, details of FIG. 7 are shown to illustrate the connections between adjacent coil units 10 and spacer 30 along the stack assembly 100. The coupler rings 112 join each adjacent unit. Fasteners, such as cap screws with suitable washers are used to secure the adjacent units together.

The present invention has been described with reference to various exemplary and illustrative embodiments. The embodiments described herein are understood as providing illustrative features of varying detail of various embodiments of the disclosed invention; and therefore, unless otherwise specified, it is to be understood that, to the extent possible, one or more features, elements, components, constituents, ingredients, structures, modules, and/or aspects of the disclosed embodiments may be combined, separated, interchanged, and/or rearranged with or relative to one or more other features, elements, components, constituents, ingredients, structures, modules, and/or aspects of the disclosed embodiments without departing from the scope of the disclosed invention. Accordingly, it will be recognized by persons having ordinary skill in the art that various substitutions, modifications or combinations of any of the exemplary embodiments may be made without departing from the scope of the invention. In addition, persons skilled in the art will recognize, or be able to ascertain using no more than routine experimentation, many equivalents to the various embodiments of the invention described herein upon review of this specification. Thus, the invention is not limited by the description of the various embodiments, but rather by the claims.

What is claimed is:

1. An electrical coil unit comprising:
a coil member comprising (i) a bobbin made of a non-conducting fiberglass impregnated resin material, the bobbin having outer and inner surfaces and defining an open interior, and (ii) an insulated copper wire coiled around the outer surface of the bobbin member in multiple layers;
an iron containing metal housing defining an open interior having a central axis, an exterior surface, and being configured for receiving the coil member therein, the exterior surface of the housing having a plurality of fins extending longitudinally in a direction substantially parallel to the central axis; and,
a coating material encapsulating the coil member within the housing to form an integrated coil unit.

2. The coil unit recited in claim 1 wherein the copper wire is insulated with fiberglass filaments.

3. The coil unit recited in claim 2 wherein the fiberglass filaments comprise a plurality of fiberglass threads each thread having a diameter of 0.0002 to 0.0003 inches (0.0058 to 0.00762 mm), wherein at least one filament is tightly wrapped in a clockwise direction and at least a second filament is tightly wrapped in a counterclockwise direction around the length of wire.

4. The coil unit recited in claim 1 wherein the coating material is a cured silicone.

5. The coil unit recited in claim 1 wherein the bobbin is made of a fiberglass impregnated epoxy resin.

6. The coil unit recited in claim 1 wherein the ends of the insulated copper wire extend outwardly from the coil unit for electrically connecting the coil unit to an external connector.

7. The coil unit recited in claim 1 wherein the housing is made of a carbon steel.

8. The coil unit recited in claim 1 wherein the coil unit is operable at temperatures up to 500° F.

9. The coil unit recited in claim 1 wherein the coil unit is operable at temperatures between 390 and 500° F.

10. The coil unit recited in claim 1 wherein the fins comprise a plurality of semi-circular grooves formed into the exterior surface of the housing.

11. The coil unit recited in claim 1 wherein the housing further comprises a first annular plate defining a floor section on which the coil member sits.

12. The coil unit recited in claim 11 wherein the first annular plate is removably fastened to the housing.

13. The coil unit recited in claim 1 wherein the housing further comprises a second annular plate defining a roof section for securing the coil member within the housing.

14. The coil unit recited in claim 13 wherein the second annular plate is removably fastened to the housing.

15. The coil unit recited in claim 1 wherein the wire is unvarnished.

16. An assembly comprising:
a plurality of electrical coil units as recited in claim 1 stacked axially to form a stacked column of coil units.

17. The assembly recited in claim 16 wherein there are at least four stacked coil units.

18. The assembly recited in claim 17 further comprising at least one spacer positioned between two stacked coil units.

19. The assembly recited in claim 18 wherein the housing of each coil unit and the spacer are made of a carbon steel.

20. The assembly recited in claim 16 wherein the column of coil units comprises a first coil unit, a second coil unit stacked on the first coil unit, a spacer stacked on the second coil unit, a third coil unit stacked on the spacer, a fourth coil unit stacked on the third coil unit.

21. The assembly recited in claim 20 further comprising a fifth coil unit in the column of coil units, the fifth coil unit positioned between one of the first and second coil units or the third and fourth coil units.

22. The assembly recited in claim 16 wherein the fins on the housing in each coil unit comprise a plurality of semi-circular grooves formed into the exterior surface of the housing.

23. The assembly recited in claim 16 wherein the copper wire in each coil unit is insulated with fiberglass filaments.

24. The assembly recited in claim 23 wherein the fiberglass filaments comprise a plurality of fiberglass threads each thread having a diameter of 0.0002 to 0.0003 inches (0.0058 to 0.00762 mm), wherein at least one filament is tightly wrapped in a clockwise direction and at least a second filament is tightly wrapped in a counterclockwise direction around the length of wire.

25. The assembly recited in claim 16 wherein the coating material in each coil unit is a cured silicone.

26. The assembly recited in claim 16 wherein the bobbin in each coil unit is made of a fiberglass impregnated epoxy resin.

27. The assembly recited in claim 16 wherein each housing of each coil unit further comprises a first annular plate defining a floor section on which the coil member sits and a second annular plate defining a roof section for securing the coil member within the housing.

28. An electrical coil unit comprising a coil member encapsulated with cured silicone within an iron-containing metal housing wherein the housing has an increased surface area to better transfer heat and provide air flow during operation.
